(19) United States
(12) Patent Application Publication
(10) Pub. No.: US 2020/0292748 A1
(43) Pub. Date: Sep. 17, 2020

(54) BACKLIGHT UNIT, DISPLAY DEVICE INCLUDING THE SAME, AND METHOD OF MANUFACTURING BACKLIGHT UNIT

(71) Applicant: Samsung Display Co., Ltd., Yongin-Si (KR)

(72) Inventors: JINHO PARK, Suwon-si (KR); Seong-Yong HWANG, Hwaseong-si (KR); Hansol KANG, Cheonan-si (KR); Juyoun SON, Cheonan-si (KR); JAE SUL AN, Hwaseong-si (KR)

(21) Appl. No.: 16/798,821

(22) Filed: Feb. 24, 2020

(30) Foreign Application Priority Data
Mar. 14, 2019 (KR) 10-2019-0029026

(51) Int. Cl. F21V 8/00

(52) U.S. Cl. CPC G02B 6/0061; G02B 6/0065; G02B 6/0038; G02B 6/0043

(57) ABSTRACT

A backlight unit includes a display panel, a light guide plate beneath the display panel, a light source spaced apart from the light guide plate in a first direction, a plurality of first optical patterns beneath the light guide plate while extending in the first direction and being arranged in a second direction intersecting the first direction, and a plurality of second optical patterns beneath the plurality of first optical patterns. Each of the plurality of first optical patterns has a quadrangle shape when viewed in the first direction.

This application claims priority to Korean Patent Application No. 10-2019-0029026, filed on Mar. 14, 2019, and all the benefits accruing therefrom under 35 U.S.C. § 119, the content of which in its entirety is herein incorporated by reference.

### BACKGROUND

### 1. Field

Exemplary embodiments of the invention relate to a backlight unit, a display device including the same, and a method of manufacturing a backlight unit.

### 2. Description of the Related Art

A light-receiving type display device includes a display panel that uses external light to display an image and a backlight unit that provides the display panel with light. The display panel includes a plurality of pixels for generating the image. The pixels display the image by adjusting transmittance of the light provided from the backlight unit.

The backlight unit is broadly classified into an edge type backlight unit and a direct type backlight unit. The edge type backlight unit includes a light guide plate and a light source adjacent to one surface of the light guide plate. The one surface of the light guide plate is defined as a light incident part, and light generated from the light source is provided through the light incident part to the light guide plate.

### SUMMARY

When an edge type backlight unit is used, optical density is highest at a light incident part of a light guide plate. In this case, an increased quantity of light is upwardly released through a certain portion of the light guide plate which is close to the light incident part. Accordingly, luminance efficiency may be reduced due to an occurrence of light leakage at a portion close to the light incident part of the light guide plate.

Exemplary embodiments of the invention provide a backlight unit with improved luminance uniformity and a display device including the same.

Exemplary embodiments of the invention provide a simplified method of manufacturing a backlight unit.

An exemplary embodiment of the invention provides a display device including a display panel, a light guide plate beneath the display panel, a light source spaced apart from the light guide plate in a first direction, a plurality of first optical patterns beneath the light guide plate, the plurality of first optical patterns extending in the first direction and being arranged in a second direction intersecting the first direction, and a plurality of second optical patterns beneath the plurality of first optical patterns. Each of the plurality of first optical patterns may have a quadrangle shape when viewed in the first direction.

In an exemplary embodiment, the plurality of second optical patterns may be spaced apart from each other along the first direction and the second direction.

In an exemplary embodiment, a refractive index of each of the pluralities of first and second optical patterns may be equal to or greater than a refractive index of the light guide plate.

In an exemplary embodiment, each of the plurality of second optical patterns may include a base resin and a scattering particle.

In an exemplary embodiments, the plurality of second optical patterns may include a material identical to a material of the plurality of first optical patterns.

In an exemplary embodiment, each of the plurality of second optical patterns may include an outermost surface having a curvature.

In an exemplary embodiment, a width of each of the plurality of second optical patterns may be equal to or less than 20 times a height of each of the plurality of second optical patterns.

In an exemplary embodiment, the display device may further include a base layer between the light guide plate and the plurality of first optical patterns. The base layer may include a material identical to a material of the plurality of first optical patterns.

In an exemplary embodiment, the display device may further include a low refractive layer on the light guide plate, the low refractive layer having a refractive index less than a refractive index of the light guide plate, and a wavelength conversion layer on the low refractive layer. The wavelength conversion layer may include a wavelength conversion particle that converts a wavelength of light provided from the light source.

In an exemplary embodiment, an angle between a lateral surface of each of the plurality of first optical patterns and a plane parallel to the first direction and the second direction may be in a range between about 75 degrees (°) and about 90°.

In an exemplary embodiment, the light guide plate may include a first lateral surface that faces the light source, and a second lateral surface that is spaced apart in the first direction from the first lateral surface. A portion of light provided from the light source may travel from the first lateral surface toward the second lateral surface by the plurality of first optical patterns and the light guide plate. A portion of the light provided from the light source may travel toward the display panel by the plurality of second optical patterns.

In an exemplary embodiment, sizes of the plurality of second optical patterns may be substantially the same. On a plan, a number of the plurality of second optical patterns disposed on an area adjacent to the second lateral surface may be greater than a number of the plurality of second optical patterns disposed on an area adjacent to the first lateral surface.

In an exemplary embodiment, sizes of ones among the plurality of second optical patterns may be less than sizes of other ones among the plurality of second optical patterns. The ones among the plurality of second optical patterns may be disposed on an area adjacent to the first lateral surface, and the other ones among the plurality of second optical patterns may be disposed on an area adjacent to the second lateral surface.

An exemplary embodiment of the invention provides a method of manufacturing a backlight unit including forming a light guide plate, forming a plurality of first optical patterns on one surface of the light guide plate, and forming a plurality of second optical patterns on the plurality of first optical patterns. The plurality of first optical patterns may extend along a first direction and are arranged along a second direction intersecting the first direction. Each of the plurality of first optical patterns may have a quadrangle shape when viewed in the first direction.

In an exemplary embodiment, the forming the plurality of second optical patterns may include printing an ink on the plurality of first optical patterns. The ink may include a scattering particle.

In an exemplary embodiment, the method of manufacturing a backlight unit may further include forming a mold that has a shape corresponding to shapes of the plurality of first optical patterns and shapes of the plurality of second optical patterns, and forming a preliminary layer on the one surface of the light guide plate. The forming the plurality of first optical patterns and the plurality of second optical patterns may include using the mold to imprint the preliminary layer.

In an exemplary embodiment, the forming the mold may include forming a plurality of first stamp patterns on a substrate that extend along the first direction and are arranged along the second direction, each of the plurality of first stamp patterns having a quadrangle shape when viewed in the first direction, printing an ink on the plurality of first stamp patterns to form a plurality of second stamp patterns, and using the plurality of first stamp patterns and the plurality of second stamp patterns to form the mold having an engraved shape that corresponds to shapes of the plurality of first stamp patterns and shapes of the plurality of second stamp patterns.

An exemplary embodiment of the invention provides a display device including a light guide plate, a light source spaced apart from the light guide plate in a first direction, a low refractive layer on the light guide plate, the low refractive layer having a refractive index less than a refractive index of the light guide plate, a wavelength conversion layer on the low refractive layer, the wavelength conversion layer including a wavelength conversion particle that converts a wavelength of light provided from the light source, a plurality of first optical patterns beneath the light guide plate, the plurality of first optical patterns extending in the first direction and being arranged in a second direction intersecting the first direction, and a plurality of second optical patterns beneath the plurality of first optical patterns, the plurality of second optical patterns being arranged along the first direction and the second direction. Each of the plurality of first optical patterns may have a quadrangle shape when viewed in the first direction.

In an exemplary embodiment, each of the plurality of second optical patterns may include a base resin and a scattering particle.

In an exemplary embodiment, the plurality of second optical patterns may include a material identical to a material of the plurality of first optical patterns. Each of the plurality of second optical patterns may have an outermost surface with a curvature.

### BRIEF DESCRIPTION OF THE DRAWINGS

The above and other exemplary embodiments, advantages and features of this disclosure will become more apparent by describing in further detail exemplary embodiments thereof with reference to the accompanying drawings, in which:

FIG. 1 illustrates a perspective view showing an exemplary embodiment of a display device according to the invention.

FIG. 2 illustrates a schematic diagram showing a pixel depicted in FIG. 1.

FIG. 3 illustrates a cross-sectional view showing a wavelength conversion layer depicted in FIG. 1.

FIG. 4A illustrates a plan view partially showing an exemplary embodiment of a backlight unit according to the invention.

FIG. 4B illustrates a cross-sectional view taken along line I-I′ of FIG. 4A.

FIG. 5 illustrates a cross-sectional view taken along a section corresponding to line I-I′ of FIG. 4A.

FIG. 6A illustrates an enlarged cross-sectional view partially showing an exemplary embodiment of an optical layer according to the invention.

FIG. 6B illustrates an enlarged cross-sectional view partially showing an exemplary embodiment of an optical layer according to the invention.

FIG. 7 illustrates a plan view partially showing an exemplary embodiment of a backlight unit according to the invention.

FIG. 8 illustrates a cross-sectional view partially showing an exemplary embodiment of a backlight unit according to the invention.

FIG. 9 illustrates a plan view partially showing an exemplary embodiment of a backlight unit according to the invention.

FIG. 10 illustrates a plan view partially showing an exemplary embodiment of a backlight unit according to the invention.

FIGS. 11A to 11C illustrate cross-sectional views showing an exemplary embodiment of a method of manufacturing a portion of a backlight unit according to the invention.

FIGS. 12A to 12G illustrate cross-sectional views showing an exemplary embodiment of a method of manufacturing a portion of a backlight unit according to the invention.

### DETAILED DESCRIPTION

In this description, when a certain component (or region, layer, portion, etc.) is referred to as being “on”, “connected to”, or “coupled to” other component(s), the certain component may be directly disposed on, directly connected to, or directly coupled to the other component(s) or at least one intervening component may be present therebetween.

Like numerals indicate like components. Moreover, in the drawings, thicknesses, ratios, and dimensions of components are exaggerated for effectively explaining the technical contents.

The term “and/or” includes one or more combinations defined by associated components.

It will be understood that, although the terms first, second, etc. may be used herein to describe various components, these components should not be limited by these terms. These terms are only used to distinguish one component from another component. For example, a first component could be termed a second component, and vice versa without departing from the scope of the invention. Unless the context clearly indicates otherwise, the singular forms are intended to include the plural forms as well.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items.

In addition, the terms “beneath”, “lower”, “above”, “upper”, and the like are used herein to describe one component's relationship to other component(s) illustrated in the drawings. The relative terms are intended to encompass different orientations in addition to the orientation depicted in the drawings.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms used herein including technical and scientific terms have the same meaning generally understood by one of ordinary skilled in the art. Also, terms as defined in dictionaries generally used should be understood as having meaning identical or meaning contextually defined in the art and should not be understood as ideally or excessively formal meaning unless definitely defined herein.

It should be understood that the terms “comprise”, “include”, “have” , and the like are used to specify the presence of stated features, integers, steps, operations, components, elements, or combinations thereof, but do not preclude the presence or addition of one or more other features, integers, steps, operations, components, elements, or combinations thereof

The following will now describe exemplary embodiments of the invention in conjunction with the accompanying drawings.

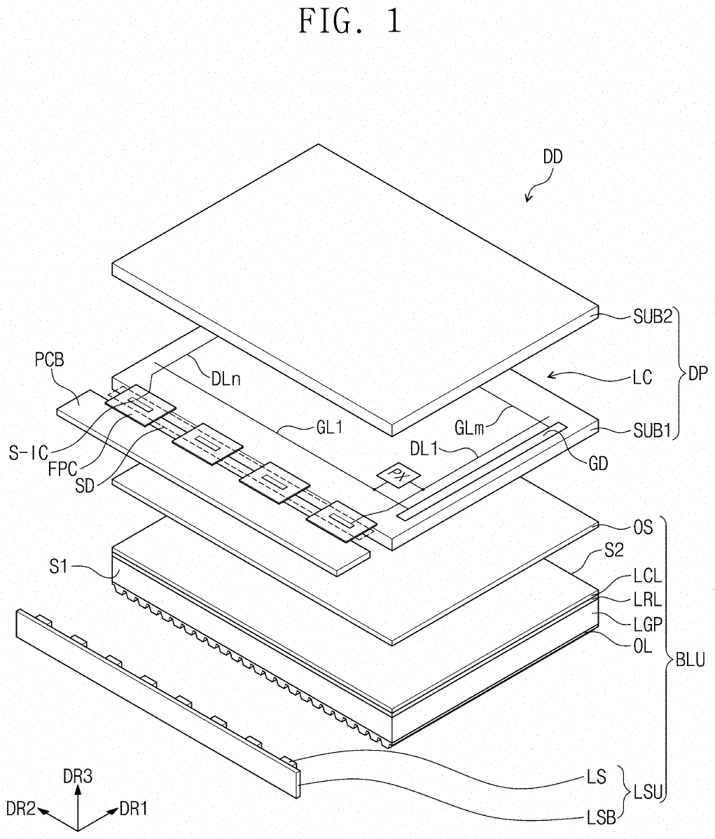

FIG. 1 illustrates a perspective view showing an exemplary embodiment of a display device according to the invention.

Referring to FIG. 1, a display device DD may include a display panel DP, a gate driver GD, a data driver SD, a printed circuit board PCB, and a backlight unit BLU.

The display panel DP may be shaped like a plate having a plane defined by a first direction DR1 and a second direction DR2. The display device DD is illustrated to have a flat shape in FIG. 1, but the invention is not limited thereto. In other exemplary embodiments, the display device DD may be a curved display device. In an exemplary embodiment, from the viewpoint of a user toward the display device DD, the display device DD may be a display device that is concavely or convexly curved as a whole. In an alternative exemplary embodiment, the display device DD may be a partially bent display device, for example.

The display panel DP may be a light-receiving type display panel. The display panel DP may transmit or block light received from the display panel DP, thereby providing an image. In an exemplary embodiment, the display panel DP may be a liquid crystal display panel, for example, but the invention are not limited. The display panel DP may generate an image corresponding to input image data, and provide the generated image on a front surface thereof. In an exemplary embodiment, the display panel DP may provide the generated image toward a third direction DR3, for example.

The display panel DP may include a first substrate SUB1, a second substrate SUB2 facing the first substrate SUB1, a liquid crystal layer LC between the first and second substrates SUB1 and SUB2.

The first substrate SUB1 may be provided thereon with a plurality of pixels PX, a plurality of gate lines GL1 to GLm, and a plurality of data lines DL1 to DLn. The subscripts “m” and “n” are natural numbers. For convenience of description, FIG. 1 shows one pixel among the plurality of pixels PX, but substantially, a plurality of pixels PX may be disposed on the first substrate SUB1.

The gate lines GL1 to GLm may be insulated from and intersect the data lines DL1 to DLn. The gate lines GL1 to GLm may extend in the second direction DR2 and have electrical connection with the gate driver GD. The data lines DL1 to DLn may extend in the first direction DR1 and have electrical connection with the data driver SD. Each of the pixels PX may be electrically connected to a corresponding one of the gate lines GL1 to GLm and to a corresponding one of the data lines DL1 to DLn.

The gate driver GD may be disposed on a portion of the first substrate SUB1, which portion is adjacent to one of sides of the first substrate SUB1. The first substrate SUB1 may be disposed (e.g., mounted) thereon with the gate driver GD which is in the shape of an amorphous silicon thin film transistor (“TFT”) gate driver circuit or an oxide silicon TFT gate driver circuit and which is provided in the same process used for forming transistors of the pixels PX.

In other exemplary embodiments, the gate driver GD may be provided in the shape of a plurality of driver chips disposed (e.g., mounted) on flexible circuit boards, and a tape carrier package (“TCP”) scheme is employed to connect the gate driver GD to the first substrate SUB1. In an alternative exemplary embodiment, a chip on glass (“COG”) scheme may be used to mount the driver chips of the gate driver GD on the first substrate SUB1.

The data driver SD may include a plurality of source driver chips S-IC disposed (e.g., mounted) on flexible circuit boards FPC. FIG. 1 exemplarily illustrates four source driver chips S-IC and four flexible circuit boards FPC, but the numbers of the source driver chips S-IC and the flexible circuit boards FPC may be changed depending on a size of the display panel DP.

One sides of the flexible circuit boards FPC may be connected to one side of the first substrate SUB1. The one sides of the first substrate SUB1 may be defined to indicate one among long sides of the first substrate SUB1. Other sides of the flexible circuit boards FPC may be connected to the printed circuit board PCB, which other sides stand opposite to the sides of the flexible circuit boards FPC. The source driver chips S-IC may be connected through the flexible circuit boards FPC to the first substrate SUB1 and the printed circuit board PCB.

A timing controller (not shown) may be disposed on the printed circuit board PCB. The printed circuit board PCB may be disposed (e.g., mounted) thereon with the timing controller in the shape of an integrated circuit chip. The timing controller may be electrically connected through the flexible circuit boards FPC to the gate driver GD and the data driver SD. The timing controller may output a gate control signal to the gate driver GD, and output a data control signal and image data to the data driver SD.

The gate driver GD may receive the gate control signal from the timing controller, and in response to the gate control signal, may generate a plurality of gate signals. The gate driver GD may sequentially output the gate signals. The gate signals may be provided through the gate lines GL1 to GLm to the pixels PX.

The data driver SD may receive image data and a data control signal from the timing controller. In response to the data control signal, the data driver SD may generate analog data voltages corresponding to the image data, and output the data voltages to the data lines DL1 to DLn. The data voltages may be provided through the data lines DL1 to DLn to the pixels PX.

In response to the gate signals provided through the gate lines GL1 to GLm, the pixels PX may be provided with the data voltages through the data lines DL1 to DLn.

The backlight unit BLU may provide the display panel DP with light. In an exemplary embodiment, the backlight unit BLU may be an edge type backlight unit, for example.

The backlight unit BLU may include a light source unit LSU, a light guide plate LGP, a low refractive layer LRL, a wavelength conversion layer LCL, an optical sheet OS, and an optical layer OL.

The light source unit LSU may be disposed spaced apart in the first direction DR1 from the light guide plate LGP. The light guide plate LGP may include a first lateral surface Si and a second lateral surface S2 that are spaced apart from each other in the first direction DR1, and the light source unit LSU may be disposed facing the first lateral surface S1. The first lateral surface Si may be defined as a light incident part, and the second lateral surface S2 may be defined as a light output part.

The light source unit LSU may include a light source substrate LSB extending in the second direction DR2 and a plurality of light sources LS lying on the light source substrate LSB. The light sources LS may be disposed at a regular interval in the second direction DR2. The light sources LS may be disposed to face the first lateral surface S1 of the light guide plate LGP. The light sources LS may each generate a first light, and the first light may be provided to the first lateral surface Si of the light guide plate LGP.

The light guide plate LGP may include a transparent plastic or glass. The light guide plate LGP may be disposed beneath the display panel DP. The light guide plate LGP may have top and bottom surfaces each of which is a plane defined by the first direction DR1 and the second direction DR2. The third direction DR3 may thus be a direction perpendicular to the top and bottom surfaces of the light guide plate LGP.

The low refractive layer LRL may be disposed between the display panel DP and the light guide plate LGP. The low refractive layer LRL may be disposed on the light guide plate LGP and in contact with the top surface of the light guide plate LGP.

The low refractive layer LRL may have a refractive index less than that of the light guide plate LGP. In an exemplary embodiment, the refractive index of the light guide plate LGP may be in a range between about 1.49 and about 1.5, for example, and the refractive index of the low refractive layer LRL may be about 1.25, for example. The low refractive layer LRL may be a porous low refractive layer. A portion of light traveling toward the top surface of the light guide plate LGP may be totally reflected from an interface between the light guide plate LGP and the low refractive layer LRL. In an exemplary embodiment, depending on an exit angle of the first light, the first light may be provided to the low refractive layer LRL or may be totally reflected from the interface between the light guide plate LGP and the low refractive layer LRL, for example. The totally reflected light may progress toward the second lateral surface S2 of the light guide plate LGP.

The wavelength conversion layer LCL may be disposed between the display panel DP and the low refractive layer LRL. The wavelength conversion layer LCL may be placed on the low refractive layer LRL and in contact with a top surface of the low refractive layer LRL.

Light provided to the low refractive layer LRL may be directed toward the wavelength conversion layer LCL. The wavelength conversion layer LCL may convert the first light into a white light, and output the white light upwardly. The white light may diffuse in the wavelength conversion layer LCL and may exit upwardly. In an exemplary embodiment, the first light may be a blue light, for example.

The wavelength conversion layer LCL may include a plurality of dots that convert the blue light into the white light. Light converted in the wavelength conversion layer LCL may be provided to the optical sheet OS.

The optical sheet OS may be disposed between the display panel DP and the wavelength conversion layer LCL. The optical sheet OS may include a diffusion sheet and a prism sheet on the diffusion sheet. The diffusion sheet may serve to diffuse the white light provided from the wavelength conversion layer LCL. The prism sheet may focus the white light, which is diffused from the diffusion sheet, in an upper direction perpendicular to a plane. The white light passing through the prism sheet may travel in the upper direction, and then the display panel DP may be provided with the white light having a uniform luminance distribution. In other exemplary embodiments, the optical sheet OS may be omitted.

The optical layer OL may be disposed beneath the light guide plate LGP. The optical layer OL may guide the first light to travel toward the second lateral surface S2 and to travel toward the display panel DP, which first light is incident on the first lateral surface S1. A configuration of the optical layer OL will be further discussed in detail.

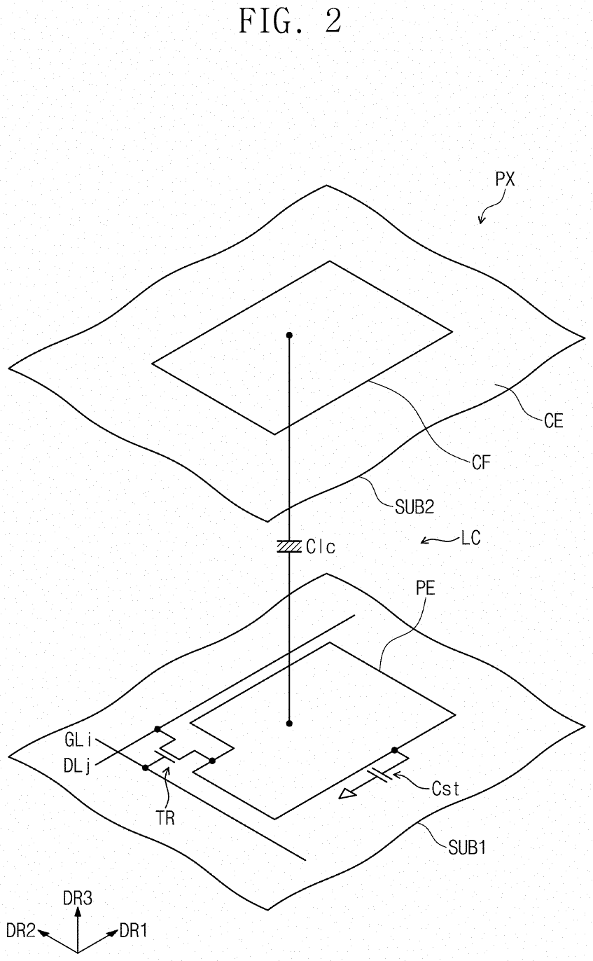

FIG. 2 illustrates a schematic diagram showing a pixel depicted in FIG. 1.

For convenience of description, FIG. 2 illustrates a pixel PX connected to a gate line GLi and a data line DLj, and other pixels PX of the display panel DP may be configured identically to the pixel PX shown in FIG. 2.

Referring to FIG. 2, the pixel PX may include a transistor TR connected to the gate line GLi and the data line DLj, a liquid crystal capacitor Clc electrically connected to the transistor TR, and a storage capacitor Cst electrically connected in parallel to the liquid crystal capacitor Clc. In other exemplary embodiments, the storage capacitor Cst may be omitted. The subscripts “i” and “j” are natural numbers.

The transistor TR may be disposed on the first substrate SUB1. The transistor TR may include a control electrode connected to the gate line GLi, an input electrode connected to the data line DLj, and an output electrode connected to the liquid crystal capacitor Clc and the storage capacitor Cst.

The liquid crystal capacitor Clc may include a pixel electrode PE disposed on the first substrate SUB1, a common electrode CE disposed on the second substrate SUB2, and the liquid crystal layer LC disposed between the pixel electrode PE and the common electrode CE. The pixel electrode PE may be electrically connected to the output electrode of the transistor TR.

In FIG. 2, the pixel electrode PE is exemplarily illustrated in the shape of a non-slit structure, but the shape of the pixel electrode PE is not limited thereto. In an exemplary embodiment, the pixel electrode PE may have a slit structure including a cross-shaped stem and a plurality of branches radially extending from the stem, for example.

The common electrode CE may be disposed beneath the second substrate SUB2. In an alternative exemplary embodiment, the common electrode CE may be disposed on the first substrate SUB1. In this case, one or more of the pixel electrode PE and the common electrode CE may include a slit structure.

The storage capacitor Cst may include the pixel electrode PE, a storage electrode (not shown) branched from a storage line (not shown), and a dielectric layer disposed between the pixel electrode PE and the storage electrode. The storage line may be disposed on the first substrate SUB1, and the storage line and the gate lines (refer to GL1 to GLm of FIG. 1) may be provided simultaneously with each other on the same layer. The storage electrode may partially overlap the pixel electrode PE. The storage line may be supplied with a storage voltage having a constant voltage level. In an alternative exemplary embodiment, the storage line may be supplied with a common voltage. The storage capacitor Cst may serve to supplement a charge amount of the liquid crystal capacitor Clc.

The pixel PX may further include a color filter CF that displays one of red, green, and blue colors. In exemplary embodiments, as shown in FIG. 2, the color filter CF may be disposed on the second substrate SUB2. In other exemplary embodiments, the color filter CF may be disposed on the first substrate SUB1.

The transistor TR may be turned on in response to a gate signal provided through the gate line GLi. A data voltage received through the data line DLj may be provided through the turned-on transistor TR to the pixel electrode PE of the liquid crystal capacitor Clc. The common electrode CE may be supplied with a common voltage.

A difference in voltage levels of the data voltage and the common voltage may produce an electric field between the pixel electrode PE and the common electrode CE. The electric field produced between the pixel electrode PE and the common electrode CE may change orientation of liquid crystal molecules of the liquid crystal layer LC. The liquid crystal molecules driven by the electric field may adjust optical transmittance, thereby displaying an image.

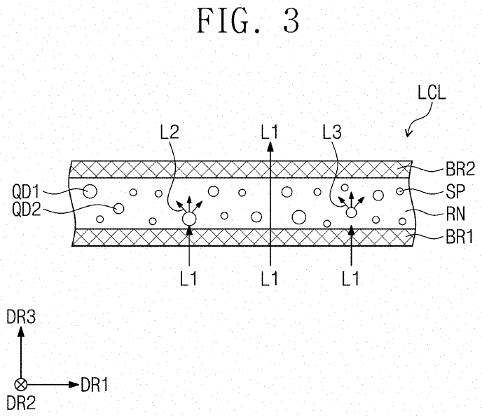

FIG. 3 illustrates a cross-sectional view showing a wavelength conversion layer depicted in FIG. 1.

Referring to FIG. 3, the wavelength conversion layer LCL may include a first barrier layer BR1, a second barrier layer BR2 disposed above the first barrier layer BR1, a base resin RN disposed between the first barrier layer BR1 and the second barrier layer BR2, a first light-emitting substance QD1, a second light-emitting substance QD2, and a scattering particle SP.

Each of the first and second barrier layers BR1 and BR2 may have a single-layered structure or a multi-layered structure. Each of the first and second barrier layers BR1 and BR2 may include an inorganic material. In an exemplary embodiment, the inorganic material may be, for example, silicon nitride or silicon oxide.

The base resin RN may be a polymer resin. In an exemplary embodiment, the base resin RN may be an acryl-based resin, a urethane-based resin, a silicon-based resin, or an epoxy-based resin, for example. The base resin RN may be a transparent resin. The first light-emitting substance QD1, the second light-emitting substance QD2, and the scattering particle SP may be distributed in the base resin RN.

The first and second light-emitting substances QD1 and QD2 may include a material that absorbs light to convert its wavelength to emit the light. In an exemplary embodiment, the first and second light-emitting substances QD1 and QD2 may be quantum dots, for example.

The first light-emitting substance QD1 may absorb a first light L1 to emit a second light L2. The second light-emitting substance QD2 may absorb the first light L1 to emit a third light L3. The second light L2 may be a red light, and the third light L3 may be a green light. The first light L1, the second light L2, and the third light L3 may be mixed to produce a white light.

The scattering particle SP may scatter light. In an exemplary embodiment, the scattering particle SP may include SiO2, TiO2, organic beads, or a combination thereof. In an exemplary embodiment, the organic beads may include, for example, polymethylmethacrylate (“PMMA”).

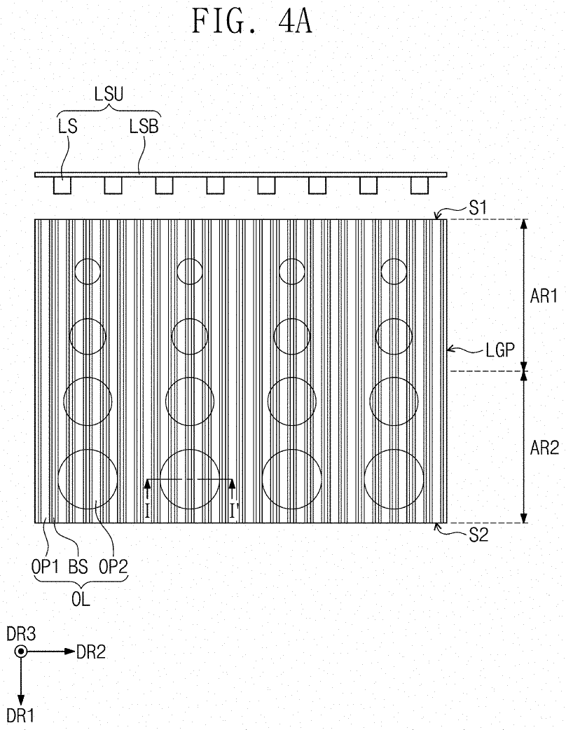

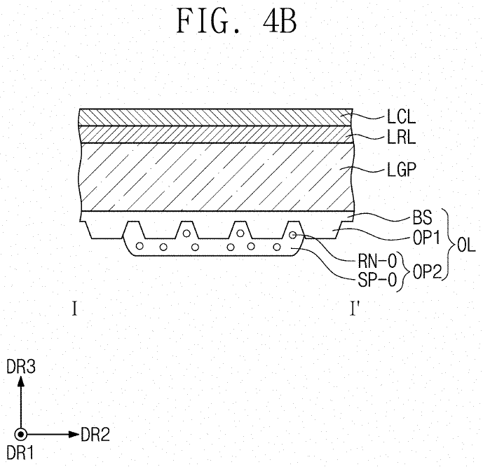

FIG. 4A illustrates a plan view partially showing an exemplary embodiment of a backlight unit according to the invention. FIG. 4B illustrates a cross-sectional view taken along line I-I′ of FIG. 4A.

Referring to FIGS. 4A and 4B, the optical layer OL may include a base layer BS, first optical patterns OP1, and second optical patterns OP2.

The base layer BS may be in contact with the bottom surface of the light guide plate LGP. The first optical patterns OP1 may downwardly protrude from the base layer BS. The base layer BS and the first optical patterns OP1 may be unitary. The base layer BS may be connected to all of the first optical patterns OP1 spaced apart from each other. Therefore, one or ones of the first optical patterns OP1 may be prevented from being separated from the light guide plate LGP.

The base layer BS and the first optical patterns OP1 may include the same material. In an exemplary embodiment, the base layer BS and the first optical patterns OP1 may include a material having a refractive index equal to or greater than that of the light guide plate LGP, for example.

Each of the first optical patterns OP1 may extend along the first direction DR1. The first direction DR1 may intersect an extending direction of the first lateral surface S1 to which light is provided. In an exemplary embodiment, the first optical patterns OP1 may extend in a direction away from the light incident part toward the light output part, for example. The first optical patterns OP1 may be spaced apart from each other in the second direction DR2.

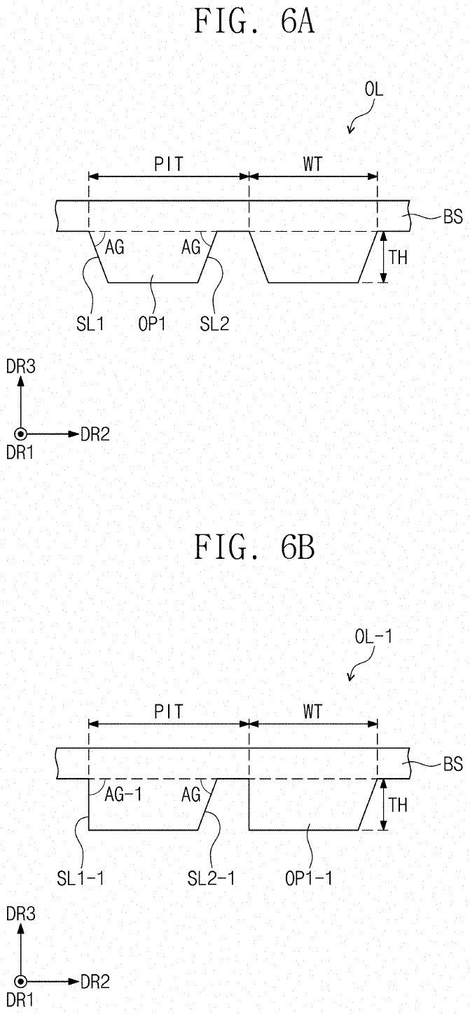

When viewed in the first direction DR1, the first optical patterns OP1 may have quadrangle shapes. In an exemplary embodiment, when viewed in the first direction DR1, the first optical patterns OP1 may have inverted trapezoidal shapes, for example. Therefore, each of the first optical patterns OP1 may include parallel top and bottom sides and opposite oblique sides defined by inclined surfaces. A width, parallel to the second direction DR2, of each of the first optical patterns OP1 may decrease as approaching downwardly. In an alternative exemplary embodiment, as long as the first optical patterns OP1 have quadrangle shapes, the first optical patterns OP1 may have various shapes. The various shapes of the first optical patterns OP1 will be further discussed below in detail with reference to FIGS. 6A and 6B.

The number of the first optical patterns OP1 may be greater than that of the light sources LS. In correspond to a single light source LS, a predetermined number of the first optical patterns OP1 may be disposed beneath the light guide plate LGP. Although eight light sources LS and twenty-four first optical patterns OP1 are exemplarily illustrated, the numbers of the light sources LS and the first optical patterns OP1 are not limited thereto. In addition, although sixteen second optical patterns OP2 are exemplarily illustrated, the number of the second optical patterns OP2 is not limited thereto, either.

The second optical patterns OP2 may be disposed beneath the first optical patterns OP1. The second optical patterns OP2 may be light output patterns by which light travels toward the display panel (refer to DP of FIG. 1). The second optical patterns OP2 may include a base resin RN-O and a scattering particle SP-O. Light incident on the second optical patterns OP2 may be scattered by the scattering particle SP-O, and then directed toward the display panel (refer to DP of FIG. 1).

The second optical patterns OP2 may be spaced apart from each other along the first direction DR1 and the second direction DR2. Sizes of the second optical patterns OP2 may be different depending on positions. In an exemplary embodiment, the sizes of the second optical patterns OP2 may be changed based on distances from the light sources LS, for example. The longer distances from the light sources LS, the greater sizes of the second optical patterns OP2. In exemplary embodiments, the sizes of the second optical patterns OP2 placed on a first area AR1 adjacent to the first lateral surface S1 may be less than those of the second optical patterns OP2 placed on a second area AR2 adjacent to the second lateral surface S2.

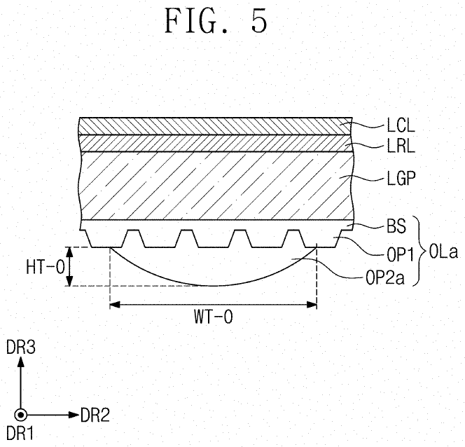

FIG. 5 illustrates a cross-sectional view taken along a section corresponding to line I-I′ of FIG. 4A.

Referring to FIG. 5, an optical layer OLa may include a base layer BS, first optical patterns OP1, and second optical patterns OP2a.

The base layer BS, the first optical patterns OP1, and the second optical patterns OP2a may be unitary. The base layer BS, the first optical patterns OP1, and the second optical patterns OP2a may thus include the same material. In an exemplary embodiment, the base layer BS, the first optical patterns OP1, and the second optical patterns OP2a may include a material having a refractive index equal to or greater than that of the light guide plate LGP, for example.

Light incident on the second optical patterns OP2a may be totally reflected from outermost surfaces of the second optical patterns OP2a, and then directed toward the display panel (refer to DP of FIG. 1). Each of the second optical patterns OP2a may include an outermost surface having a curvature.

Because the second optical patterns OP2a include no scattering particles, the second optical patterns OP2a may have more convex shapes than those of the second optical patterns OP2 shown in FIG. 4B. In an exemplary embodiment, a width WT-O of each of the second optical patterns OP2a may be equal to or less than 20 times a height HT-O of each of the second optical patterns OP2a, for example. The width WT-O may be a maximum width parallel to the second direction DR2. The height HT-O may correspond to a maximum distance, which is parallel to the third direction DR3, between a plane parallel to a bottom surface of the first optical pattern OP1 and the outermost surface of the second optical pattern OP2a.

FIG. 6A illustrates an enlarged cross-sectional view partially showing an exemplary embodiment of an optical layer according to the invention. For convenience of description, FIG. 6A exaggeratingly illustrates a portion of the optical layer OL on which two first optical patterns OP1 are disposed.

Referring to FIG. 6A, each of the first optical patterns OP1 may have symmetrical first and second lateral surfaces SL1 and SL2 that are defined by opposite oblique sides of an inverted trapezoidal shape. In an exemplary embodiment, the first lateral surface SL1 and the second lateral surface SL2 may have an inclination angle AG relative to a plane parallel to the first direction DR1 and the second direction DR2, for example. In an exemplary embodiment, the inclination angle AG may be in a range between about 70° and about 90°, for example.

A width WT of each of the first optical patterns OP1 may be defined to indicate a distance, along the second direction DR2, between a top end of the first lateral surface SL1 and a top end of the second lateral surface SL2. The top ends may be portions in contact with the base layer BS. A thickness TH of each of the first optical patterns OP1 may be defined to indicate a distance, along the third direction DR3, between top and bottom surfaces of the each first optical pattern OP1.

The width WT of each of the first optical patterns OP1 may be greater than the thickness TH of each of the first optical patterns OP1. In an alternative exemplary embodiment, the width WT of each of the first optical patterns OP1 may be less than the thickness TH of each of the first optical patterns OP1. As one example, the width WT may be in a range between about 10 micrometers (μm) and about 300 μm, and the thickness TH may be in a range between about 3 μm and about 50 μm, for example.

A distance, along the second direction DR2, between the top end of the first lateral surface SL1 of an h^{th} first optical pattern and the top end of the first lateral surface SL1 of an (h+1)^{th} first optical pattern may be defined to indicate a pitch PIT of the first optical patterns OP1, and the pitch PIT may be in a range between about 20 μm and about 500 μm, for example. Here, h may be a natural number. Of the first optical patterns OP1 shown in FIG. 6A, the h^{th} first optical pattern may be a first optical pattern placed on a left side, and the (h+1)^{th} first optical pattern may be a first optical pattern placed on a right side.

FIG. 6B illustrates an enlarged cross-sectional view partially showing an exemplary embodiment of an optical layer according to the invention.

For convenience of description, FIG. 6B exaggeratingly illustrates a portion of an optical layer OL-1 on which two first optical patterns OP1-1 are disposed.

Referring to FIG. 6B, each of the first optical patterns OP1-1 may have asymmetrical first and second lateral surfaces SL1-1 and SL2-1 that are defined by opposite oblique sides of an inverted trapezoidal shape. In an exemplary embodiment, the first lateral surface SL1-1 and the second lateral surface SL2-1 may have different inclination angles AG-1 and AG relative to a plane parallel to the first direction DR1 and the second direction DR2, for example. In an exemplary embodiment, the inclination angle AG-1 may be about 90°, and the inclination angle AG may be in a range between about 75° and less than about 90°, for example.

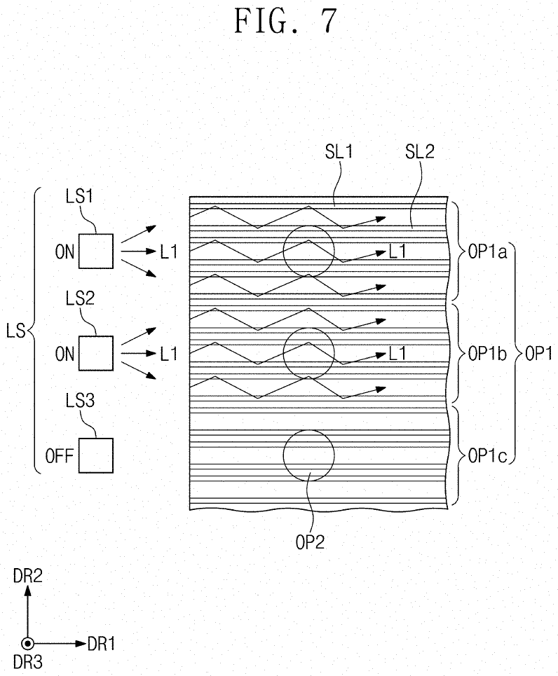

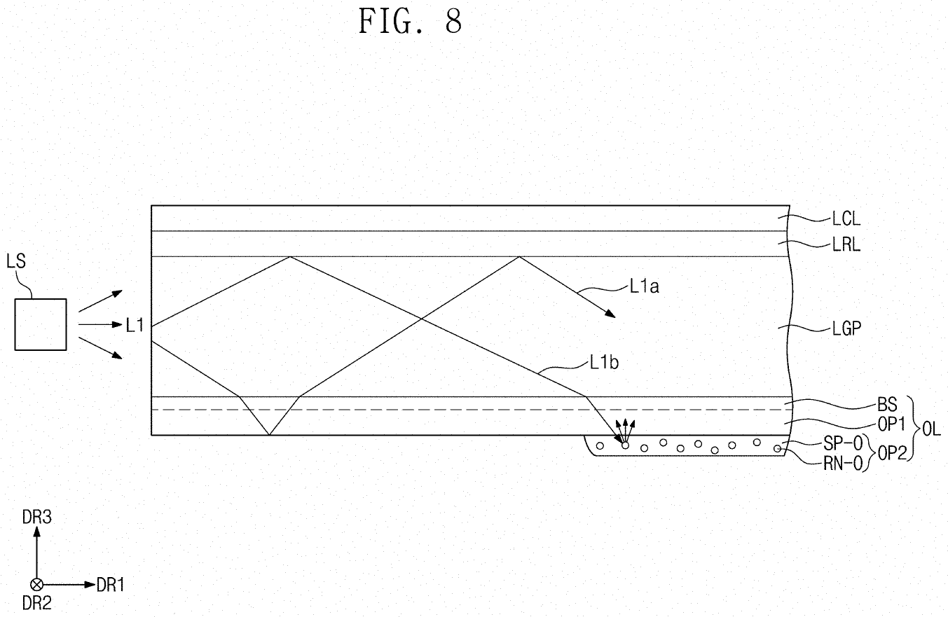

FIG. 7 illustrates a plan view partially showing an exemplary embodiment of a backlight unit according to the invention. FIG. 8 illustrates a cross-sectional view partially showing an exemplary embodiment of a backlight unit according to the invention.

FIG. 7 shows a traveling direction of the first light L1 on a two-dimensional plane defined by the first direction DR1 and the second direction DR2, and FIG. 8 shows a traveling direction of the first light L1 in a plan view defined by the first direction DR1 and the third direction DR3.

Referring to FIG. 7, a local dimming may be defined to refer to an operation that selectively controls the light sources LS corresponding to some blocks, based on luminance of an image that will be displayed on each of blocks divided from the display panel DP. In an exemplary embodiment, the display panel DP may include a first block overlapping first optical patterns OP1a, a second block overlapping first optical patterns OP1b, and a third block overlapping first optical patterns OP1c.

As a result of analysis of an image that will be displayed, high luminance may be desired to display an image on the first and second blocks of the display panel DP, and low luminance may be desired to display an image on the third block of the display panel DP. In this case, first and second light sources LS1 and LS2 may be turned on, and a third light source LS3 may be turned off Therefore, the first and second blocks may exhibit high luminance, and the third block may exhibit low luminance.

Among the light sources LS1, LS2, and LS3, the first and second light sources LS1 and LS2 may be turned on, and the third light source LS3 may be turned off. The light guide plate LGP may be provided with a first light L1 generated from the first and second light sources LS1 and LS2. The first light L1 provided to the light guide plate LGP may be directed toward the first optical patterns OP1 and the second optical patterns OP2.

The first light L1 generated from the first light source LS1 may be provided to three first optical patterns OP1a adjacent to the first light source LS1. The first light L1 provided to the first optical patterns OP1a may be reflected from the first and second lateral surfaces SL1 and SL2 of each of the first optical patterns OP1a, and then directed in the first direction DR1 from each of the first optical patterns OP1a. Accordingly, the first light L1 generated from the first light source LS1 may be guided toward specific regions defined by the first optical patterns OP1a.

A first light L1 generated from the second light source LS2 may be provided to three first optical patterns OP1b adjacent to the second light source LS2. The first light L1 provided to the first optical patterns OP1b may be reflected from the first and second lateral surfaces SL1 and SL2 of each of the first optical patterns OP1b, and then directed in the first direction DR1 from each of the first optical patterns OP1b. Accordingly, the first light L1 generated from the second light source LS2 may be guided toward specific regions defined by the first optical patterns OP1b.

Because the third light source LS3 is in the turned-off state, no first light L1 may be provided from the third light source LS3 to three first optical patterns OP1c adjacent to the third light source LS3. However, a portion of the first light L1 generated from the second light source LS2 may be provided to the first optical patterns OP1c. Nevertheless, because the third light source LS3 is in the turned-off state, luminance of a zone on which the first optical patterns OP1c are disposed may be relatively extremely lower than those of zones on which the first optical patterns OP1a and OP1b are disposed.

When the first optical patterns OP1 are not disposed, the first light L1 may not be individually guided toward each specific region, but may diffuse into all regions of the light guide plate LGP. Therefore, it may be difficult to perform the local dimming. In contrast, when the first optical patterns OP1 are disposed, the first light L1 may be individually guided toward each specific region (e.g., each block of the display panel DP) and thus it may be possible to control luminance of specific regions independently of each other.

Although the first, second, and third light sources LS1, LS2, and LS3 are illustrated for exemplary explanation, other light sources LS may selectively operate to perform the local dimming, based on luminance of corresponding blocks.

Differently from some exemplary embodiments of the invention, when a first optical pattern (referred to hereinafter as a first comparative optical pattern) has a curvature on an outer surface thereof, various angles may be made between a normal line to the outer surface and a light output surface of the light guide plate LGP. In this case, a portion of light incident on the first comparative optical patterns may not be guided toward the light output part, but directed toward the display panel (refer to DP of FIG. 1). This situation may cause light leakage and luminance non-uniformity. The light output surface may be parallel to a plane defined by the first direction DR1 and the second direction DR2. In contrast, according to an exemplary embodiment of the invention, the first and second lateral surfaces SL1 and SL2 of each of the first optical patterns OP1 may have flat shapes. In addition, each of the first and second lateral surfaces SL1 and SL2 may have an angle equal of about 75° or higher relative to the light output surface. Accordingly, light incident on the first and second lateral surfaces SL1 and SL2 may have a reduced probability of being directed toward the display panel DP. In conclusion, shapes of the first optical patterns OP1 may increase a quantity of light guided in the first direction DR1.

Referring to FIG. 8, the optical layer OL and a boundary between the light guide plate LGP and the low refractive layer LRL may allow the first light L1 to travel in the first direction DR1. In an exemplary embodiment, a first light L1a may be totally reflected from the outer surface of the first optical pattern OP1, and then directed in the first direction DR1, for example. A first light L1b may be incident on the second optical pattern OP2 disposed beneath the first optical pattern OP1. The first light L1b may be scattered by the scattering particle SP-O, and then directed toward the display panel (refer to DP of FIG. 1).

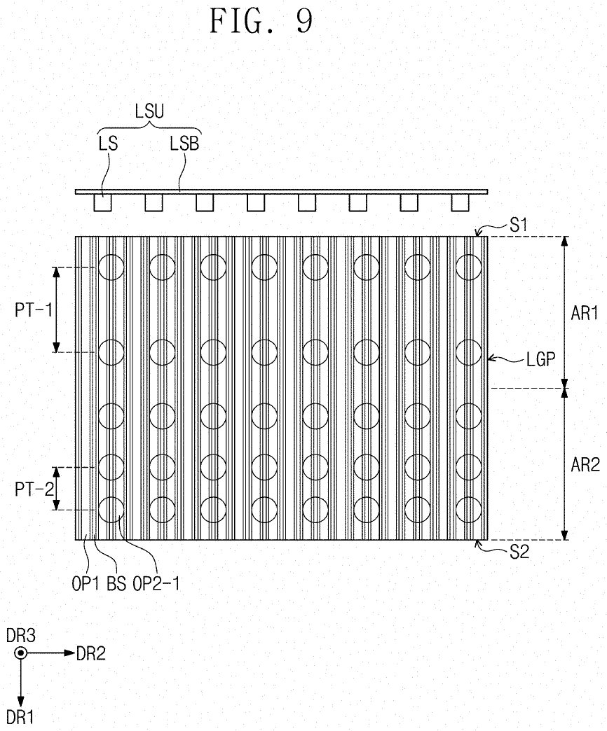

FIG. 9 illustrates a plan view partially showing an exemplary embodiment of a backlight unit according to the invention. In the description of FIG. 9, those parts the same as those discussed above with reference to FIG. 4A are allocated the same reference numerals thereto, and explanations thereof will be omitted.

Referring to FIG. 9, second optical patterns OP2-1 may have substantially the same size. The second optical patterns OP2-1 may be spaced apart from each other along the first direction DR1 and the second direction DR2. Intervals between the second optical patterns OP2-1 may be different depending on positions. In an exemplary embodiment, distances in the second direction DR2 between the second optical patterns OP2-1 may be the same as each other, for example. Unlikely, distances in the first direction DR1 between the second optical patterns OP2-1 may be different from each other.

The distance in the first direction DR1 between the second optical patterns OP2-1 disposed on the first area AR1 may be defined to refer to a first distance PT-1, and the distance in the first direction DR1 between the second optical patterns OP2-1 disposed on the second area AR2 may be defined to refer to a second distance PT-2. The first distance PT-1 may be greater the second distance PT-2. Thus, the number of the second optical patterns OP2-1 disposed on the first area AR1 may be less than that of the second optical patterns OP2-1 disposed on the second area AR2.

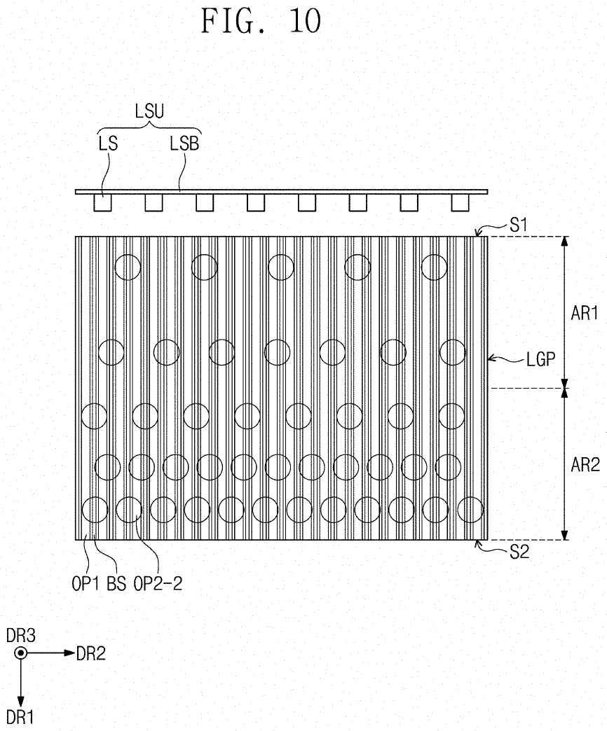

FIG. 10 illustrates a plan view partially showing an exemplary embodiment of a backlight unit according to the invention. In the description of FIG. 10, those parts the same as those discussed above with reference to FIG. 4A are allocated the same reference numerals thereto, and explanations thereof will be omitted.

Referring to FIG. 10, second optical patterns OP2-2 may have substantially the same size. The second optical patterns OP2-2 may be irregularly arranged, but the number of the second optical patterns OP2-2 disposed on the first area AR1 may be less than that of the second optical patterns OP2-2 disposed on the second area AR2.

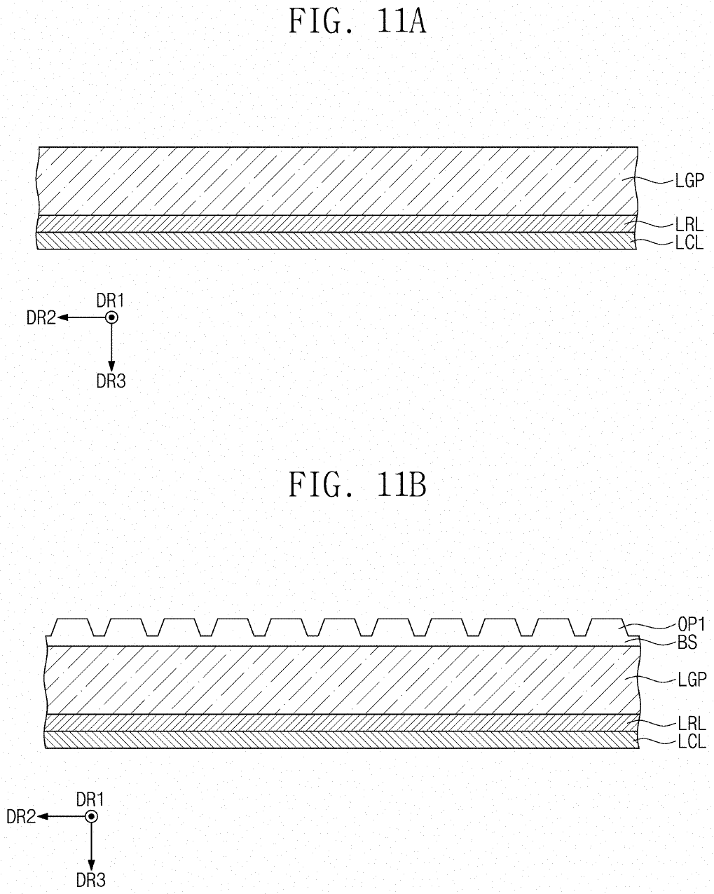

FIGS. 11A to 11C illustrate cross-sectional views showing an exemplary embodiment of a method of manufacturing a portion of a backlight unit according to the invention.

Referring to FIG. 11A, a light guide plate LGP is provided. A low refractive layer LRL is disposed on one surface of the light guide plate LGP. The low refractive layer LRL may be provided by a coating process. In an exemplary embodiment, a composition for the low refractive layer LRL may be slit-coated on the one surface of the light guide plate LGP, and then dried and cured to form the low refractive layer LRL, for example. The formation of the low refractive layer LRL, however, is not limited thereto.

A wavelength conversion layer LCL is disposed on one surface of the low refractive layer LRL. The wavelength conversion layer LCL may be provided by a coating process, but the invention is not limited thereto.

Referring to FIG. 11B, a base layer BS and first optical patterns OP1 are disposed on other surface of the light guide plate LGP. The base layer BS and the first optical patterns OP1 may be provided in the shape of sheets attached to the other surface of the light guide plate LGP. The formation of the base layer BS and the first optical patterns OP1, however, is not limited to the example discussed above. In exemplary embodiments, a preliminary layer may be disposed on one surface of the light guide plate LGP, and then imprinted to form the base layer BS and the first optical patterns OP1. In other exemplary embodiments, the first optical patterns OP1 may be provided by patterning other surface of the light guide plate LGP. In this case, the base layer BS may be omitted.

Referring to FIG. 11C, second optical patterns OP2 are disposed on the first optical patterns OP1 and the base layer BS. The second optical patterns OP2 may be provided using a printing process. In an exemplary embodiment, an inkjet machine IM may be used to form the second optical patterns OP2 on the first optical patterns OP1, for example. The second optical patterns OP2 printed on the first optical patterns OP1 may be cured by thermal curing or UV curing. Sizes of the second optical patterns OP2 may be adjusted to control an amount of ink discharged from the inkjet machine IM. The ink may include a base resin RN-O and a scattering particle SP-O.

In exemplary embodiments, no patterning process may be used in forming the second optical patterns OP2. The patterning process may include, for example, an exposure process using a mask and a development process. The printing process may be simpler than the patterning process. Therefore, in an exemplary embodiment of the invention, the fabrication of the second optical patterns OP2 may be simplified.

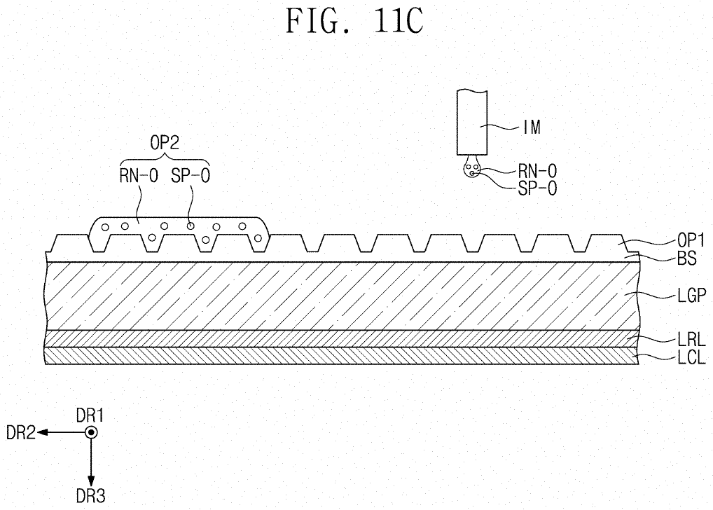

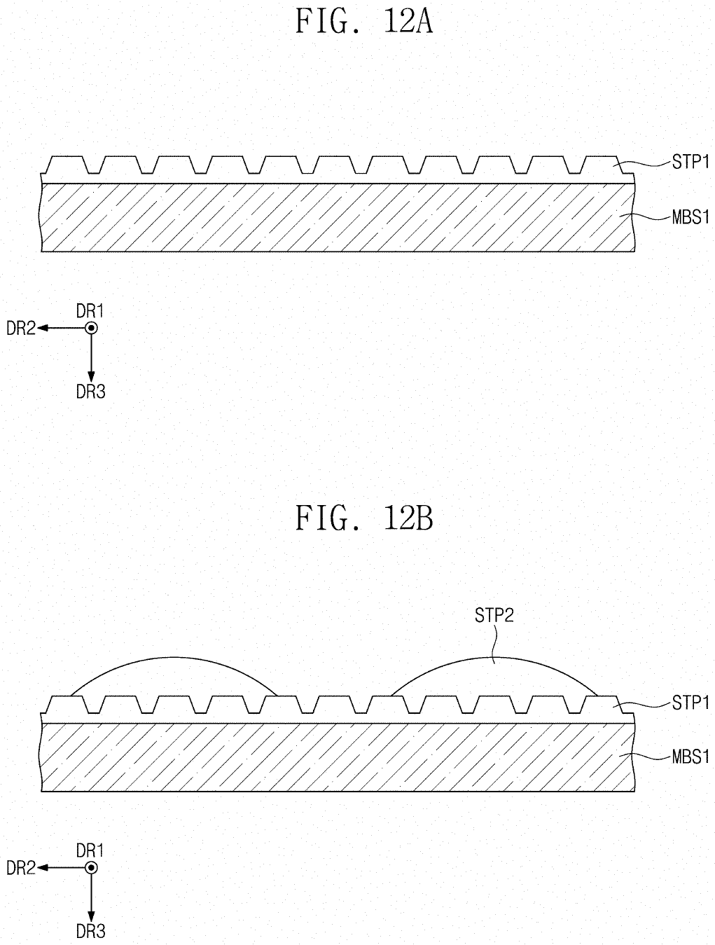

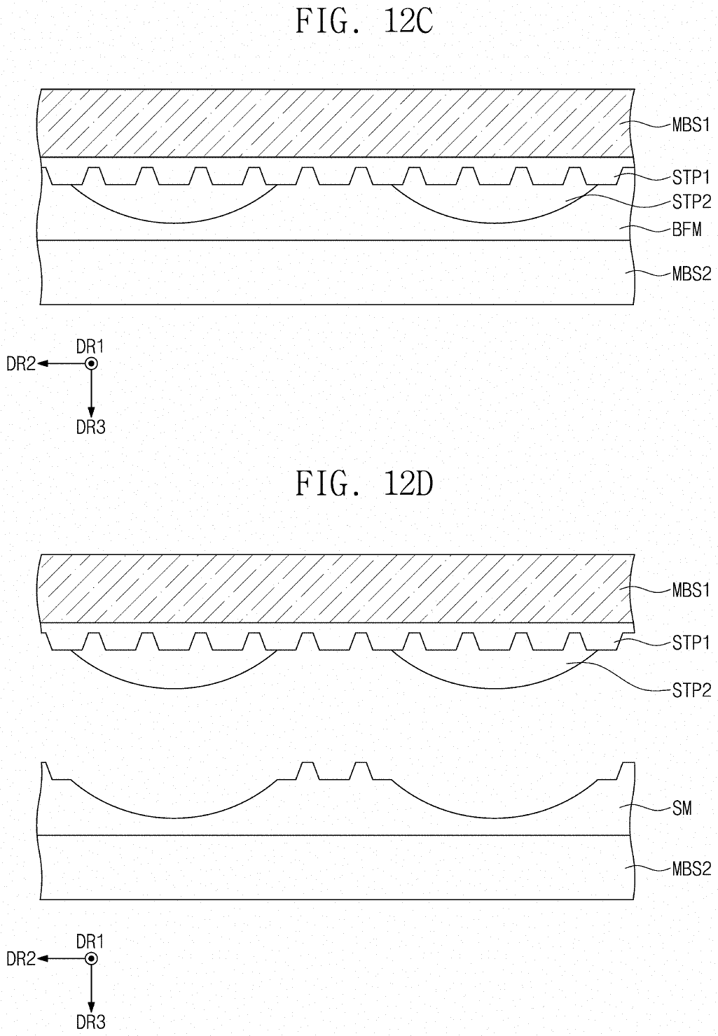

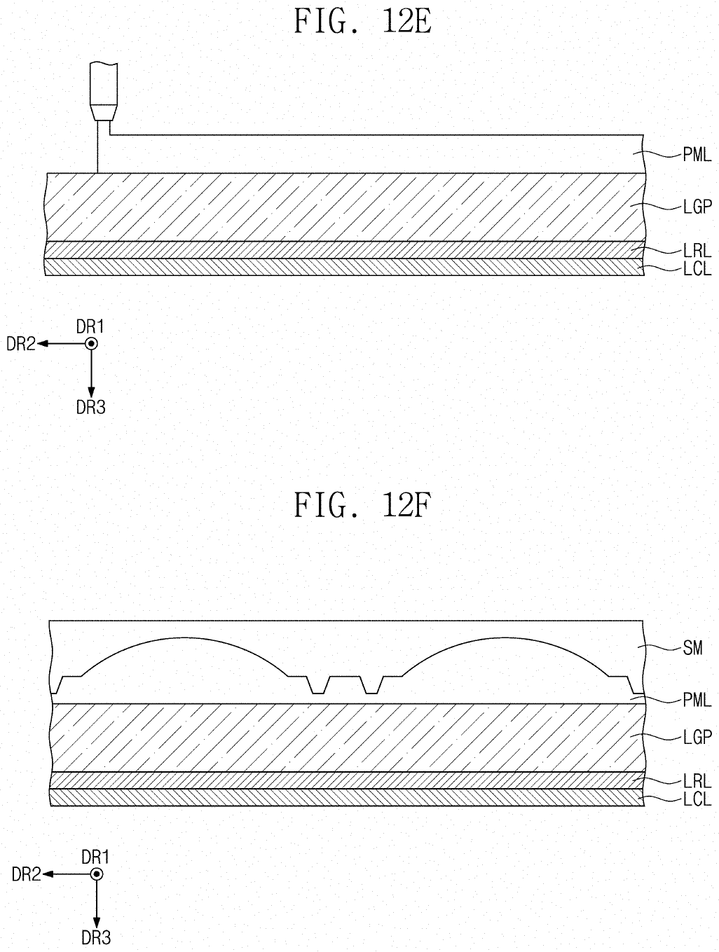

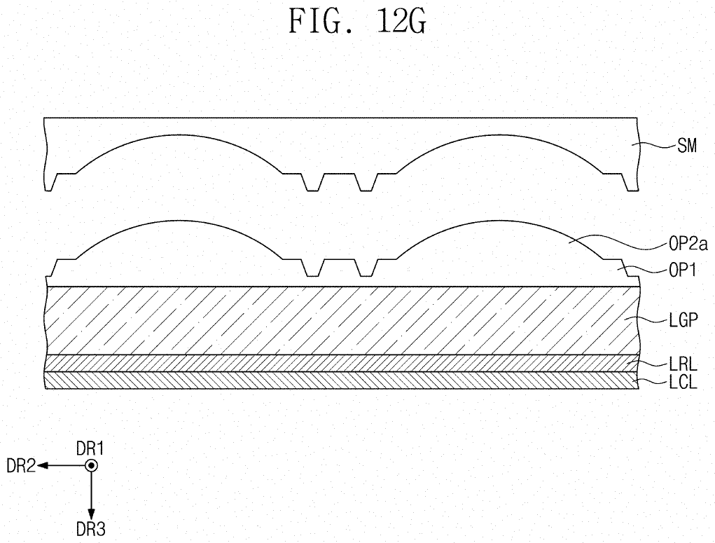

FIGS. 12A to 12G illustrate cross-sectional views showing an exemplary embodiment of a method of manufacturing a portion of a backlight unit according to the invention.

Referring to FIG. 12A, first stamp patterns STP1 are disposed on a first mold substrate MBS1. Each of the first stamp patterns STP1 may extend along a first direction DR1 and be arranged along a second direction DR2. The first stamp patterns STP1 may have quadrangle shapes when viewed in the first direction DR1. The shapes of the first stamp patterns STP1 may correspond to those of the first optical patterns OP1 discussed above with reference to FIG. 4A.

The first stamp patterns STP1 may be provided using a patterning process. In an exemplary embodiment, the patterning process may include a coating process, an exposure process using a mask, and a development process, for example.

Referring to FIG. 12B, an ink may be printed on the first stamp patterns STP1, thereby forming second stamp patterns STP2. Each of the second stamp patterns STP2 may have an outer surface with a curvature. The first mold substrate MBS1, the first stamp patterns STP1, and the second stamp patterns STP2 may be collectively referred to as a mold substrate.

Referring to FIG. 12C, a preliminary layer BFM is disposed on a second mold substrate MBS2. The mold substrate is placed on the preliminary layer BFM. Afterwards, the preliminary layer BFM is cured.

Referring to FIG. 12D, when the first mold substrate MBS1, the first stamp patterns STP1, and the second stamp patterns STP2 are separated from the second mold substrate MBS2, the preliminary layer BFM may be patterned to form a mold SM.

Referring to FIG. 12E, a preliminary layer PML is disposed on one surface of the light guide plate LGP. The preliminary layer PML may be provided by a coating process.

Referring to FIG. 12F, the mold SM is placed on the preliminary layer PML, and thereafter the preliminary layer PML is first cured.

Referring to FIG. 12G, the mold SM is separated from the preliminary layer PML, and then second cured to form first optical patterns OP1 and second optical patterns OP2a.

According to the discussion above, first optical patterns may have quadrangle shapes, and second optical patterns may be disposed beneath the first optical patterns. Light incident on the first optical patterns may be guided from a light incident part toward a light output part, and light incident on the second optical patterns may be directed toward a display panel. Therefore, it may be possible to reduce concentration of the light on a portion adjacent to the light incident part and thus to improve luminance uniformity.

The second optical patterns may be provided by an inkjet process performed on the first optical patterns, or may be provided using a mold obtained by employing a stamp pattern provided by an inkjet process. Instead of a photolithography process, an inkjet process is used to form the second optical patterns such that it is possible to simplify the fabrication of the second optical patterns.

Although the exemplary embodiments have been described with reference to a number of illustrative examples thereof, it will be understood by those of ordinary skill in the art that various changes in form and details may be made without departing from the spirit and scope of the invention as set forth in the following claims. Thus, the technical scope of the invention is not limited by the exemplary embodiments and examples described above, but by the following claims.

What is claimed is:

1. A display device, comprising:
a display panel;
a light guide plate beneath the display panel;
a light source spaced apart from the light guide plate in a first direction;
a plurality of first optical patterns beneath the light guide plate, the plurality of first optical patterns extending in the first direction and being arranged in a second direction intersecting the first direction; and
a plurality of second optical patterns beneath the plurality of first optical patterns,
wherein each of the plurality of first optical patterns has a quadrangle shape when viewed in the first direction.

2. The display device of claim 1, wherein the plurality of second optical patterns is spaced apart from each other along the first direction and the second direction.

3. The display device of claim 1, wherein a refractive index of each of the pluralities of first and second optical patterns is equal to or greater than a refractive index of the light guide plate.

4. The display device of claim 1, wherein each of the plurality of second optical patterns includes a base resin and a scattering particle.

5. The display device of claim 1, wherein the plurality of second optical patterns includes a material identical to a material of the plurality of first optical patterns.

6. The display device of claim 1, wherein each of the plurality of second optical patterns includes an outermost surface having a curvature.

7. The display device of claim 1, wherein a width of each of the plurality of second optical patterns is equal to or less than twenty times a height of each of the plurality of second optical patterns.

8. The display device of claim 1, further comprising a base layer between the light guide plate and the plurality of first optical patterns, the base layer including a material identical to a material of the plurality of first optical patterns.

9. The display device of claim 1, further comprising:
a low refractive layer on the light guide plate, the low refractive layer having a refractive index less than a refractive index of the light guide plate; and
a wavelength conversion layer on the low refractive layer, the wavelength conversion layer including a wavelength conversion particle which converts a wavelength of light provided from the light source.

10. The display device of claim 1, wherein an angle between a lateral surface of each of the plurality of first optical patterns and a plane parallel to the first direction and the second direction is in a range between about 75 degrees and about 90 degrees.

11. The display device of claim 1, wherein the light guide plate includes:
a first lateral surface which faces the light source; and
a second lateral surface which is spaced apart in the first direction from the first lateral surface,
wherein a portion of light provided from the light source travels from the first lateral surface toward the second lateral surface by the plurality of first optical patterns and the light guide plate, and
wherein a portion of the light provided from the light source travels toward the display panel by the plurality of second optical patterns.

12. The display device of claim 11, wherein
sizes of the plurality of second optical patterns are substantially the same, and
on a plan, a number of the plurality of second optical patterns disposed on an area adjacent to the second lateral surface is greater than a number of the plurality of second optical patterns disposed on an area adjacent to the first lateral surface.

13. The display device of claim 11, wherein sizes of ones among the plurality of second optical patterns are less than sizes of other ones among the plurality of second optical patterns,
the ones among the plurality of second optical patterns being disposed on an area adjacent to the first lateral surface,
the other ones among the plurality of second optical patterns being disposed on an area adjacent to the second lateral surface.

14. A method of manufacturing a backlight unit, the method comprising:
forming a light guide plate;
forming a plurality of first optical patterns on one surface of the light guide plate; and
forming a plurality of second optical patterns on the plurality of first optical patterns,
wherein the plurality of first optical patterns extends along a first direction and are arranged along a second direction intersecting the first direction, each of the plurality of first optical patterns having a quadrangle shape when viewed in the first direction.

15. The method of claim 14, wherein forming the plurality of second optical patterns includes printing an ink on the plurality of first optical patterns, the ink including a scattering particle.

16. The method of claim 14, further comprising:
forming a mold which has a shape corresponding to shapes of the plurality of first optical patterns and shapes of the plurality of second optical patterns; and
forming a preliminary layer on the one surface of the light guide plate,
wherein forming the plurality of first optical patterns and the plurality of second optical patterns includes using the mold to imprint the preliminary layer.

17. The method of claim 16, wherein forming the mold includes:
forming a plurality of first stamp patterns on a substrate which extend along the first direction and are arranged along the second direction, each of the plurality of first stamp patterns having a quadrangle shape when viewed in the first direction;
printing an ink on the plurality of first stamp patterns to form a plurality of second stamp patterns; and
using the plurality of first stamp patterns and the plurality of second stamp patterns to form the mold having an engraved shape which corresponds to shapes of the plurality of first stamp patterns and shapes of the plurality of second stamp patterns.

18. A backlight unit, comprising:
a light guide plate;
a light source spaced apart from the light guide plate in a first direction;
a low refractive layer on the light guide plate, the low refractive layer having a refractive index less than a refractive index of the light guide plate;
a wavelength conversion layer on the low refractive layer, the wavelength conversion layer including a wavelength conversion particle which converts a wavelength of light provided from the light source;
a plurality of first optical patterns beneath the light guide plate, the plurality of first optical patterns extending in the first direction and being arranged in a second direction intersecting the first direction; and
a plurality of second optical patterns beneath the plurality of first optical patterns, the plurality of second optical patterns being arranged along the first direction and the second direction,
wherein each of the plurality of first optical patterns has a quadrangle shape when viewed in the first direction.

19. The backlight unit of claim 18, wherein each of the plurality of second optical patterns includes a base resin and a scattering particle.

20. The backlight unit of claim 18, wherein the plurality of second optical patterns include a material identical to a material of the plurality of first optical patterns, each of the plurality of second optical patterns having an outermost surface with a curvature.
